(19) United States
(12) Patent Application Publication
(10) Pub. No.: US 2024/0189860 A1
(43) Pub. Date: Jun. 13, 2024

(54) CURING DEVICE AND CURING APPARATUS

(71) Applicant: Fulian Yuzhan Precision Technology Co., Ltd., Shenzhen (CN)

(72) Inventors: MANG LI, Shenzhen (CN); Jen-Hsiang TSAI, New Taipei (TW); Jian-Jun XIANG, Shenzhen (CN); Zheng-Shi XU, Shenzhen (CN); Ming-Xia XIE, Shenzhen (CN); Sheng SHEN, Shenzhen (CN); Xiao-Ping CHEN, Shenzhen (CN); Ze-Xin SHEN, Shenzhen (CN)

(21) Appl. No.: 18/526,687

(22) Filed: Dec. 1, 2023

(30) Foreign Application Priority Data
Dec. 7, 2022 (CN) 202211561091.7

(51) Int. Cl. B05D 3/06; B29C 35/08

(52) U.S. Cl. CPC B05D 3/067; B29C 35/0805; B29C 2035/0827

(57) ABSTRACT

A curing device includes a housing, a carrying plate, a moving assembly, and a light source. The housing defines an opening, The carrying plate is used for carrying a jig. The jig is used for receiving a product and an adhesive, and the jig includes a light transmitting area. The moving assembly is received in the housing and connected to the carrying plate for driving the carrying plate to move into and out of the housing from the opening. The light source is arranged in the housing for irradiating the light transmitting area of the jig to cure the adhesive in the jig. The disclosure also provides a curing apparatus.

### CROSS-REFERENCE TO RELATED APPLICATION

This application claims priority to China Application No. 202211561091.7, having a filing date of Dec. 7, 2022, filed in China National Intellectual Property Administration, the entire contents of which are hereby incorporate by reference.

### FIELD

The subject matter relates to glue or adhesive curing technologies, and more particularly, relates to a curing device and a curing apparatus having the curing device.

### BACKGROUND

In the prior art, many operations in the glue filling and curing process of the product need to be manually operated, which may easily cause potential safety hazards and defective products.

Therefore, there is room for improvement within the art.

### SUMMARY

In view of the above situation, it is necessary to provide a curing device and a curing apparatus having the curing device to improve the curing efficiency of the adhesive and eliminate potential safety hazards for operators.

According to some embodiments, a curing device includes a receiving housing, a carrying plate, a moving assembly, and a light source. The housing defines an opening. The carrying plate is used for carrying a jig. The jig is used for receiving a product and an adhesive, and the jig includes a light transmitting area. The moving assembly is received in the housing and connected to the carrying plate for driving the carrying plate to move into and out of the housing from the opening. The light source is arranged in the housing for irradiating the light transmitting area of the jig to cure the adhesive in the jig.

When the curing device is in use, the moving assembly drives the carrying plate to move from the opening to the outside of the housing, and cooperates with a mechanism such as a manipulator to place the jig with the product and the adhesive on the carrying plate, then the moving assembly drives the carrying plate to move from the opening into the housing. After that, the light source is controlled to turn on to irradiate the light transmitting area of the jig to cure the adhesive in the jig. After the adhesive in the jig is cured, the light sourced is controlled to turn off, and the moving assembly drives the carrying plate to move from the opening to the outside of the housing again, then the jig irradiated by the light source is taken away by the mechanism such as the manipulator, so as to realize the loading and unloading of the jig and the curing of the adhesive. Since the moving assembly can drive the carrying plate into and out of the housing, the mechanization of placing the jig in the housing is realized, and it is avoided to manually place the jig in the housing and take out the jig after being irradiated from the housing, thereby eliminating the safety hazards generated during manual operations, and helping to ensure the personal safety of operators. When the curing device cooperates with the mechanism such as the manipulator, the degree of mechanization of the adhesive curing operation may be improved, which is conducive to improving the curing efficiency of the adhesive and reducing the labor intensity and labor costs of operators. In addition, since the light source is located in the housing, the placement of the jig by mechanization is beneficial to improve the alignment accuracy of the light source and the jig, so that the light source can effectively irradiate the jig to cure the adhesive after being turned on. As a result, the adhesive can be cured under preset curing conditions to ensure the curing yield of the adhesive and help improve the curing quality of the adhesive.

### BRIEF DESCRIPTION OF THE DRAWINGS

Implementations of the present technology will now be described, by way of example only, with reference to the attached figures.

FIG. 1 is a view of a curing device according to an embodiment of the present disclosure.

FIG. 2 is an exploded view of the curing device of FIG. 1.

FIG. 3 is an exploded view of a carrying plate, a moving assembly and a light source of the curing device of FIG. 2.

FIG. 4 is an exploded view of a light source and a cooling pipe according to an embodiment of the present disclosure.

FIG. 5 is a diagram of a curing apparatus according to an embodiment of the present disclosure.

FIG. 6 is a diagram of an up and down movement assembly and a gripper assembly according to an embodiment of the present disclosure.

### DETAILED DESCRIPTION

It will be appreciated that for simplicity and clarity of illustration, where appropriate, reference numerals have been repeated among the different figures to indicate corresponding or analogous components. The description is not to be considered as limiting the scope of the embodiments described herein. The drawings are not necessarily to scale and the proportions of certain parts may be exaggerated to better illustrate details and features of the present disclosure.

It should be understood that, the terms “first” and “second” are used to distinguish between elements and are not used to denote a particular order or imply a number of technical features, therefore, unless specifically defined, features described as “first” and “second” may expressly or implicitly include one or more of the stated features. In the description of the present application, “plurality” means “two or more”, unless otherwise expressly and specifically defined.

In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described.

The term “comprising,” when utilized, means “including, but not necessarily limited to”; it specifically indicates open-ended inclusion or membership in the so-described combination, group, series, and the like.

A description of the hereinafter described embodiments of the disclosure is presented herein with reference to the figures by way of exemplification and not as a limitation.

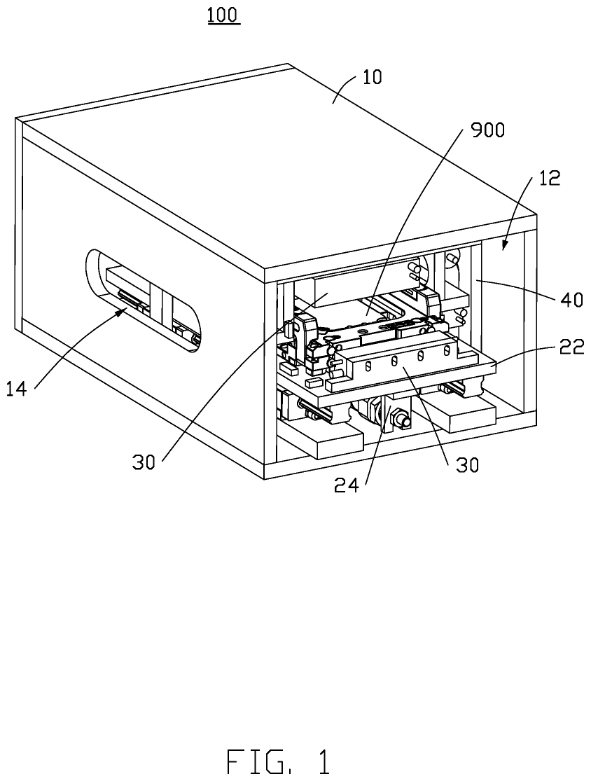

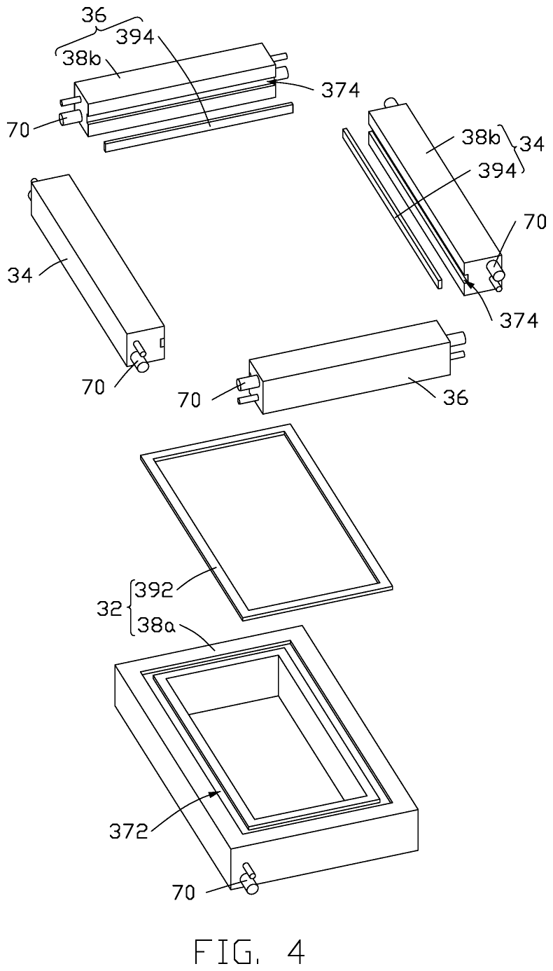

Referring to FIGS. 1 and 4, an embodiment of a curing device 100 is provided for receiving a jig 900 and irradiating a light transmitting area of the jig 900 to cure an adhesive (not shown) in the jig 900. A product (not shown) with the adhesive can be received in the jig 900, and when light passes through the light transmitting area of the jig 900 and irradiates the adhesive in the jig 900, the adhesive can be cured to form a structure on the product. The structure may be a small piece, such as a connecting post for subsequent connection to other parts. The structure may also be a connecting structure for connecting two parts of the product, such as a connecting structure for bonding a screen assembly and a metal sheet. The curing device 100 includes a receiving housing 10, a carrying plate 22, a moving assembly 24, and at least one light source 30.

The housing 10 defines an opening 12. The carrying plating 22 is used for carrying the jig 900. The moving assembly 24 is received in the housing 10, and the moving assembly 24 is connected with the carrying plating 22 for driving the carrying plating 22 to move into and out of the housing 10 from the opening 12. The light source 30 is arranged in the housing 10 for irradiating the light transmitting area of the jig 900 to cure the adhesive in the jig 900.

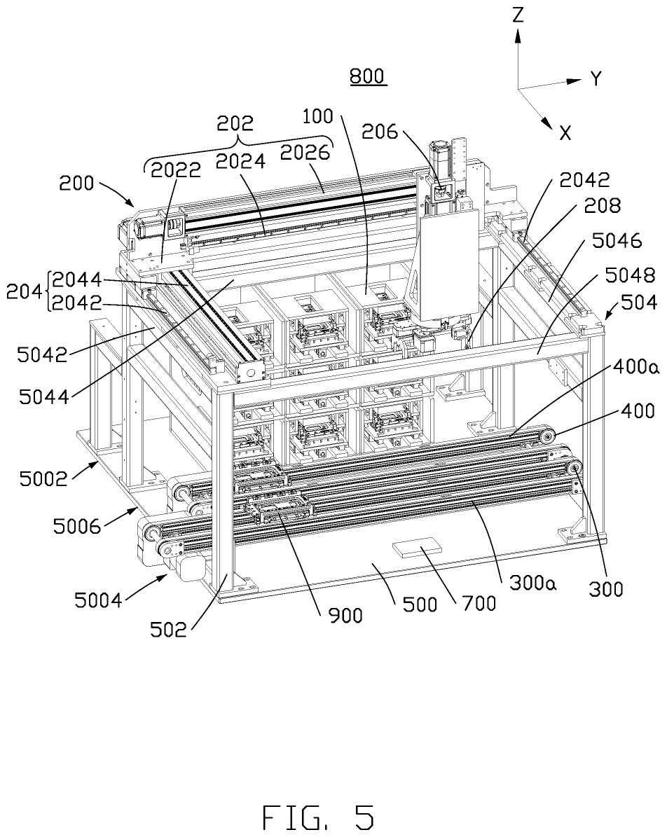

When the above-mentioned curing device 100 is in use, the moving assembly 24 drives the carrying plate 22 to move to out of the housing 10 from the opening 12, after placing the jig 900 on the carrying plate 22, the moving assembly 24 drives the carrying plate 22 to move into the housing 10 from the opening 12, then a controller 700 (shown in FIG. 5) controls the light source 30 to turn on to irradiate the light transmitting area of the jig 900 to cure the adhesive in the jig 900, after the adhesive in the jig 900 is cured, the controller 700 controls the light source 30 to turn off, and the moving assembly 24 drives the carrying plate 22 to move out of the housing 10 again from the opening 12, so as to remove the jig 900 from carrying plate 22, thereby realizing the loading and unloading of the jig 900 and the curing of the adhesive.

Since the moving assembly 24 can drive the carrying plate 22 into and out of the housing 10, a mechanization of removing the jig 900 from the housing 10 and placing the jig 900 in the housing 10 is realized, thereby preventing the operator from manually placing the jig 900 in the housing 10 and manually removing the jig 900 the jig 900 from the housing 10, and eliminating potential safety hazards caused by manual work, which is conducive to ensuring the personal safety of operators. When the curing device 100 is used in conjunction with mechanisms such as manipulators, it can also improve a degree of mechanization of the adhesive curing operation, which is conducive to improving a curing efficiency of the adhesive and reducing the labor intensity and the labor costs of the operators. In addition, because the placement of the jig 900 is realized by mechanization, a relative position between the light source 30 and the jig 900 can be accurately guaranteed, so that the light source 30 can effectively irradiate the light transmitting area of the jig 900 to cure the adhesive after being turned on. The adhesive can be cured under preset curing conditions to ensure a curing yield of the adhesive and help improve a curing quality of the adhesive.

It should be noted that the preset curing conditions refer to conditions such as light intensity and light time required for curing the adhesive, which are set according to a type of the adhesive. For example, if the preset curing conditions are that the light intensity is 2000 mW/cm² and the light time is 180 s, then under the preset curing conditions, the quality of the cured adhesive in the jig 900 is relatively high. However, when the jig 900 is placed in an inaccurate position so that the relative position between the jig 900 and the light source 30 cannot be guaranteed, under the preset curing conditions, the quality of the cured adhesive in the jig 900 is unstable, which is not conducive to improving the quality of the cured adhesive.

According to some embodiments, the light source 30 may be a UV (Ultra-Violet Ray) lamp, and the light source 30 is used to emit ultraviolet rays. It can be understood that the light source 30 may also be other light emitting elements capable of emitting light for curing the adhesive, for example, the light source 30 is a blue light lamp for emitting blue light.

Referring to FIG. 1, according to further embodiments, the housing 10 may be roughly in a shape of a cuboid, so that a structure of the housing 10 is simple and easy to manufacture, and the housings 10 can be easily stacked to reduce the occupied space when the number of the housings 10 is more than one. For example, referring to FIG. 5, the number of the housings 10 is nine, the nine housings 10 are stacked in an array.

According to further embodiments, transport holes 14 may be defined on opposite sides of the housing 10, so that an external transport mechanism such as a manipulator can transport and stack the housing 10 through the transport holes 14.

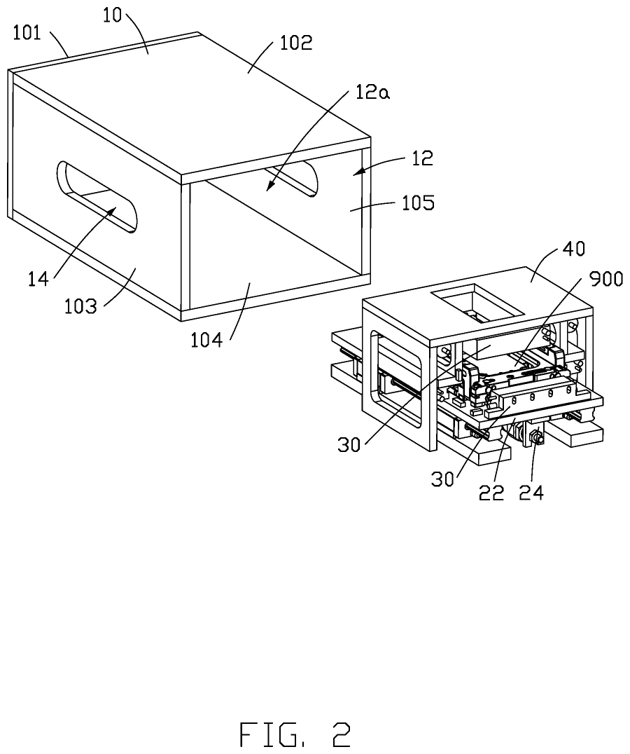

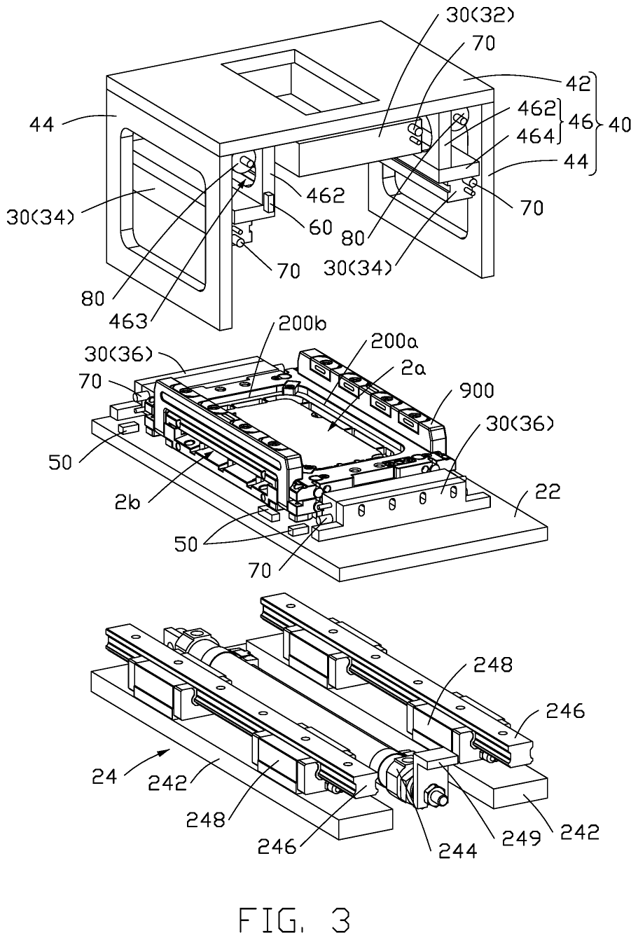

Referring to FIG. 2 and FIG. 3, according to further embodiments, the moving assembly 24 may include at least one base plate 242, at least one driving member 244, at least one guiding rail 246 arranged on the carrying plate 22, and at least one sliding block 248 slidably connected to the at least one guiding rail 246. In the illustrated embodiment, two base plates 242 are arranged on an inner bottom surface of the housing 10 and located below the carrying plate 22. Two sliding blocks 248 are respectively arranged on the two base plates 242. Two guiding rails 246 are respectively slidably connected with the two sliding blocks 248. In another embodiment, the number of the sliding blocks 248 are four, two of the sliding blocks 248 are arranged on one of the two base plates 242 at intervals and slidably connected with one of the two guiding rails 246. The driving member 244 is arranged on the inner bottom surface of the housing 10 and located between the two base plates 242. One end portion of the driving member 244 is connected to the carrying plate 22 through a L-shaped plate 249 to drive the carrying plate 22 to drive the guiding rails 246 to slide in the sliding blocks 248. According to further embodiments, there is one base plate 242 included in the moving assembly 24. The driving member 244 may be a linear cylinder, an electric telescopic rod or other functional mechanisms capable of driving the carrying plate 22 to perform linear motion. In the above-mentioned driving assembly 24, the at least one driving member 244 can drive a movement of the carrying plate 22, and the at least one guiding rail 246 and the at least one sliding block 248 can limit a movement direction of the carrying plate 22, thereby preventing the carrying plate 22 from colliding with the housing 10 or other mechanisms due to movement deviation when entering and exiting the housing 10.

Alternatively, the at least one guiding rail 246 may be arranged on the base plate 242, and the at least one sliding block 248 may be arranged on the carrying plate 22. The moving assembly 24 may be a linear module or other functional mechanisms capable of driving the carrying plate 22 to perform linear motion.

Referring to FIG. 2, according to further embodiments, the curing device 100 may further include a mounting frame 40 arranged in the housing 10 for mounting the light source 30. In some embodiments, the curing device 100 may include a plurality of light sources 30, and the plurality of light sources 30 are arranged on the mounting frame 40 at intervals, so as to irradiate the light transmitting area of the jig 900 from different directions to improve the curing efficiency of the adhesive in the jig 900. For example, a mold core (not shown) in the jig 900 cooperates with the product in the jig 900 to form a molding cavity. An adhesive injecting needle can be inserted into the jig 900 to inject liquid adhesive into the molding cavity. When the light sources 30 irradiate the molding cavity, the liquid adhesive are cured on the product. The mold core can be made of silicone.

Referring to FIG. 3, according to further embodiments, the mounting frame 40 may include a top plate 42, two side plates 44, and two mounting brackets 46.

The top plate 42 is received in the housing 10 and located above the carrying plate 22 for mounting the at least one light source 30. The side plates 44 are respectively connected to opposite sides of the top plate 42 and spaced from each other. The side plates 44 are further respectively connected to the inner bottom surface of the housing 10, and located on opposite sides of the carrying plate 22. The at least one light source 30 also may be mounted on the side plates 44.

Each of the mounting brackets 46 is arranged adjacent to one of the side plates 44. Each of the mounting brackets 46 includes a suspension plate 462 and a connecting plate 464. Suspension plates 462 of the mounting brackets 46 are respectively connected to the top plate 42 and respectively located opposite sides of the light source 30 mounted on the top plate 42. A space between the suspension plates 462 is used to receiving the jig 900. One end portion of the connecting plate 464 is connected to an end portion of the suspension plate 462 to form an L shape, another end portion of the connecting plate 464 is connected to the adjacent side plate 44.

Each light source 30 may include a first light emitting assembly 32, two second light emitting assemblies 34, and two third light emitting assemblies 36. When the jig 900 is placed on the carrying plate 22, the jig 900 includes a top surface (not labeled) facing the top plate 42, opposite first sides 200a respectively facing the connecting plates 464, and opposite second sides 200b respectively connected to the first sides and the top surface. The first light emitting assembly 32 is arranged on the top plate 42 for irradiating a portion of the light transmitting area on the top surface of the jig 900, the second light emitting assemblies 34 are respectively connected to the connecting plates 464 and respectively located on the first sides 200a of the jig 900 for irradiating portions of the light transmitting area on the first sides 200a of the jig 900 facing the connecting plates 464. The third light emitting assemblies 36 are respectively arranged on the carrying plate 22 and respectively located on the second sides 200b of the jig 900 for irradiating portions of the light transmitting area on the second sides 200b of the jig 900. A light emitting area of the first light emitting assembly 32 may be greater than a light emitting area of the second light emitting assembly 34 or a light emitting area of the third light emitting assembly 36.

Through the cooperation of the first light emitting assembly 32, the second light emitting assemblies 34, and the third light emitting assemblies 36, the adhesive in the jig 900 can be irradiated from the upper side, the left side, the right side, the front side and the rear side of the jig 900, thereby improving the curing efficiency of the adhesive. In addition, since the third light emitting assemblies 36 are arranged on the carrying plate 22, when the driving assembly 24 drives the carrying plate 22 to move out or into the housing 10, the third light emitting assemblies 36 will move together with the carrying plate 22, thereby preventing the jig 900 from colliding with the side plate 44 and/or the light source 30 on the side plate 44 when the side plate 44 is mounted and the light source 30 is mounted on the side plate 44.

The light transmitting area of the jig 900 may include a first light transmitting portion 2a and a second light transmitting portion 2b. The first light transmitting portion 2a is the top surface of the jig 900, the second light transmitting portion 2b includes areas on the first sides and the second sides of the jig 900. The upper light transmitting portion 2a may be made of transparent glass, and the side light transmitting portion 2b may be formed by hollowed-out areas on the first sides and the second sides of the jig 900.

According to further embodiments, the first light emitting assembly 32 may be a ring-shaped light source composed of LED lamps, and the first light emitting assembly 32 may meet the following parameters: a wavelength is 365 nm, a light intensity is 3000 mW/cm², an adjustable power is 30%-100%, and a distance between the first light transmitting portion 2a and the first light emitting assembly 32 can be adjusted. For example, the distance between the first light transmitting portion 2a and the first light emitting assembly 32 may be in a range of 8 mm to 12 mm, optionally 10 mm. The second light emitting assembly 34 and the third light emitting assembly 36 may be bar-shaped light sources composed of LED lamps, the second light emitting assembly 34 and the third light emitting assembly 36 may respectively meet the following parameters: a wavelength is 365 nm, a light intensity is 4000 mW/cm², an adjustable power is 10%-100%, a distance between the second light emitting assembly 34 and a part of the second light transmitting portion 2b on the first side adjacent to the second light emitting assembly 34 can be adjusted, and a distance between the third light emitting assembly 36 and a part of the second light transmitting portion 2b on the second side adjacent to the third light emitting assembly 36 can be adjusted. For example, the distance between the second light emitting assembly 34 and the part of the second light transmitting portion 2b on the first side adjacent to the second light emitting assembly 34, or the distance between the third light emitting assembly 36 and the part of the second light transmitting portion 2b on the second side adjacent to the third light emitting assembly 36 may be in a range of 8 mm to 12 mm, optionally 10 mm.

According to some embodiments, the side plates 44 also may be respectively connected to the carrying plate 22, so that the mounting frame 40 can be moved together with the carrying plate 22.

Referring to FIG. 2, according to some embodiments, the housing 10 may include a rear plate 101, an upper plate 102, a left plate 103, a lower plate 104, and a right plate 105. The upper plate 102, the left plate 103, the lower plate 104, and the right plate 105 are sequentially connected to form a ring frame and define a cavity 12a and the opening 12 communicating with the cavity 12a and the external environment. The rear plate 101 is located on a side of the ring frame facing away from the opening 12, and one end of the rear plate 101 is connected to an end of the upper plate 102, another end of the rear plate 101 is connected to an end of the lower plate 104. The carrying plate 22 is arranged in the cavity 12a and on the lower plate 104. The light source 30 for irradiating the rear side of the jig 900 may be installed on the rear plate 101 or may be installed on a side plate 44 arranged on a portion of the carrying plate 22 close to the rear plate 101. Referring to FIG. 3, according to further embodiments, the curing device 100 may further include at least one light sensor 50 and a temperature sensor 60. The at least one light sensor 50 is arranged in the housing 10 for monitoring a light intensity of the light emitted by the light source 30 to ensure that the light intensity of the light emitted by the light source 30 can effectively cure the adhesive in the jig 900. The temperature sensor 60 is arranged in the housing 10 for monitoring a temperature of the jig 900 to prevent the curing yield of the adhesive from being affected by a high temperature of the jig 900 when the jig 900 is irradiated by the light source 30.

According to some embodiments, the at least one light sensor 50 is mounted on the carrying plate 22, the number of the at least one light sensor 50 is equal to the number of the light sources 30, and each of the at least one light sensor 50 corresponds to one of the light sources 30, so as to monitor the light intensity of the light emitted by each of the light sources 30. The temperature sensor 60 is mounted on one of the mounting brackets 46, and the temperature sensor 60 is arranged toward the jig 900 so as to monitor the temperature of the jig 900.

According to some embodiments, when the number of the at least one light sensor 50 is more than one, some of the light sensors 50 may be mounted on the side plates 44, and some of the light sensors 50 may be mounted on the carrying plate 22. It can be understood that the position of each of the light sensors 50 may be set according to actual needs. The temperature sensor 60 may be arranged on the left side, the right side or other positions of the jig 900, and the position of the temperature sensor 60 may be set according to actual needs.

Referring to FIG. 3 and FIG. 4, according to further embodiments, the curing device 100 may further include a cooling pipe 70. The cooling pipe 70 communicates with an external liquid storage tank and is used to reduce a temperature of the light source 30 when circulating fluid is introduced into the cooling pipe 70.

According to some embodiment, in order to match a ring-shaped mold core, the first light emitting assembly 32 includes a first light-transmitting shell 38a with an annular groove 372 and at least one first light-emitting member 392. The cooling pipe 70 includes a plurality of straight pipe portions connected in sequence, and one of the plurality of straight pipe portions is embedded in the first light-transmitting shell 38a. The annular groove 372 is used for receiving a plurality of strip-shaped first light-emitting members 392 or a ring-shaped first light-emitting member 392. The second light emitting assembly 34 and the third light emitting assembly 36 may have the same structure, and each of the second light emitting assembly 34 and the third light emitting assembly 36 includes a second light-transmitting shell 38b with a strip-shaped groove 374 and at least one second light-emitting member 394. One of the plurality of straight pipe portions of the cooling pipe 70 is embedded in the second light-transmitting shell 38b, and the strip-shaped groove 374 is used for receiving a plurality of granular second light-emitting members 394 or a strip-shaped second light-emitting member 394. The first light-emitting member 392 and the second light-emitting member 394 may be UV lamps or blue light lamps. The cooling pipe 70 is embedded in the light-transmitting shells 38a and 38b, which is beneficial to cool down the UV lamp or the blue light lamp embedded in the light-transmitting shells 38a and 38b to increase the service life of the UV lamp or the blue light lamp. According to some embodiments, a light emitting area of the first light emitting assembly 32 is greater than light emitting areas of the second light emitting assembly 34 and the third light emitting assembly 36.

When the curing device 100 is in use, the controller 700 controls the external liquid storage tank to continuously supply fluid to the cooling pipe 70, the fluid flows through the cooling pipe 70 and returns to the external liquid storage tank, the heat generated by the light source 30 is taken away by the fluid flowing through the cooling pipe 70 through heat exchange, so that the temperature of the light source 30 is maintained within a reasonable range such as 30 degrees Celsius, which ensures the stable use of the light source 30 and helps to improve the service life of the light source 30. The fluid flowing through the cooling pipe 70 may be normal temperature water or ice water.

Referring to FIG. 3, according to some embodiments, a through hole 463 is defined by the suspension plate 462, and the curing device 100 may further include at least one air-blowing member 80. The at least one air-blowing member 80 is received in the housing 10 and located between the top plate 42 and the connecting plate 464. The at least one air-blowing member 80 is used to communicate with an external air source to blow air to the jig 900 through the through hole 463 to reduce the temperature of the jig 900 after curing the adhesive in the jig 900. When the temperature sensor 60 detects that the temperature of the jig 900 is high, the controller 700 controls the air-blowing member 80 to blow air to the jig 900, so that air circulation is formed in the housing 10. The circulating air takes away the heat generated by the jig 900 to reduce the temperature of the jig 900, so that the curing yield of the adhesive in the jig 900 may be ensured. The air-blowing member 80 may be an air nozzle, a tubular object with an air outlet, or other objects capable of sending air to the housing 10. According to further embodiments, when the jig 900 is taken away after the adhesive in the jig 900 is solidified, air can also be blown to the jig 900 through the air-blowing member 80 to quickly reduce the temperature of the jig 900, thereby preventing the jig 900 from affecting the yield rate of the cured adhesive due to the high temperature of the jig 900.

According to further embodiments, the number of the air-blowing members 80 may be five, and the five air-blowing members 80 are used to blow air to the front side, the rear side, the left side, the right side, and the top side of the jig 900 from five directions, so as to effectively reduce the temperature of the jig 900. In some embodiments, the number of the air-blowing members 80 may be more or less, and the locations of the air-blowing members 80 may be arranged according to the actual needs.

During the use of the curing device 100, for example, when the temperature sensor 60 detects the temperature of the jig 900 is greater than 50 degrees Celsius, controller 700 the controls the at least one air-blowing member 80 to blow air into the housing 10, and the air circulation is formed in the housing 10 to take away the heat generated by the jig 900 to reduce the temperature of the jig 900. When the temperature sensor 60 detects the temperature of the jig 900 is less than 40 degrees Celsius or 50 degrees Celsius, the controller 700 controls the air-blowing member 80 to stop blowing air into the housing 10. In this way , the curing yield of the adhesive in the jig 900 can be ensured by blowing air into the housing 10 through the air-blowing member 80.

Referring to FIG. 5, an embodiment of a curing apparatus 800 is provided for irradiating the jig 900 to cure the adhesive in the jig 900. The curing apparatus 800 includes a plurality of the above-mentioned curing devices 100 and a workbench 500. The plurality of the above-mentioned curing devices 100 are stacked on the workbench 500.

When the curing apparatus 800 is in use, the moving assembly 24 of the curing device 100 pushes the carrying plate 22 to move from the opening 12 to the outside of the housing 10, and cooperates with a manipulator, a three-axis linear module and other mechanisms to place the jig 900 with the product and the adhesive on the carrying plate 22, then the moving assembly 24 pulls the carrying plate 22 to move from the opening 12 into the housing 10. After that, the controller 700 controls the light source 30 to turn on to irradiate the light transmitting area of the jig 900 to cure the adhesive in the jig 900. After the adhesive in the jig 900 is cured, the controller 700 controls the light source 30 to turn off, and the moving assembly 24 pushes the carrying plate 22 to move from opening 12 to the outside of the housing 10 again, then the jig 900 irradiated by the light source 30 is taken away, so as to realize the loading and unloading of the jig 900 and the curing of the adhesive.

Since the moving assembly 24 can drive the carrying plate 22 into and out of the housing 10, the mechanization of placing the jig 900 in the housing 10 is realized, and it is avoided to manually place the jig 900 in the housing 10 and take out the jig 900 after being irradiated from the housing 10, thereby eliminating the safety hazards generated during manual operations, and helping to ensure the personal safety of operators. When the curing device 100 cooperates with mechanisms such as manipulators, the degree of mechanization of the adhesive curing operation may be improved, which is conducive to improving the curing efficiency of the adhesive and reducing the labor intensity and labor costs of operators. In addition, since the light source 30 is located in the housing 10, the placement of jig 900 by mechanization is beneficial to improve the alignment accuracy of the light source 30 and the jig 900, so that the light source 30 can effectively irradiate the jig 900 to cure the adhesive after being turned on. As a result, the adhesive can be cured under preset curing conditions to ensure the curing yield of the adhesive and help improve the curing quality of the adhesive.

The number of the curing devices 100 may be nine, and the nine curing devices 100 may be arranged in an array on the workbench 500. Simultaneous operation of multiple curing devices 100 is beneficial to improve the curing efficiency of the curing apparatus 800. In addition, the plurality of curing devices 100 are arranged compactly and occupy less space, which is conducive to reducing the space occupied by the curing apparatus 800, so as to be suitable for a relatively narrow working environment, or to arrange more production devices in the same working environment to save land.

Referring to FIG. 5, the curing apparatus 800 may further includes a transfer mechanism 200, a loading mechanism 300, an unloading mechanism 400, and at least one controller 700.

The loading mechanism 300 and the curing device 100 are arranged at intervals on the workbench 500, and the loading mechanism 300 is used to transport and supply the jig 900. The transfer mechanism 200 is used to move the jig 900 on the loading mechanism 300 and place the jig 900 onto the carrying plate 22, then the moving assembly 24 can drive the jig 900 on the carrying plate 22 into and out of the housing 10 from the opening 12. The controller 700 is electrically connected to the transfer mechanism 200, and is used to control the light source 30 to turn on to irradiate the light transmitting area of the jig 900 after the jig 900 enters the housing 10, so as to cure the adhesive in the jig 900. The unloading mechanism 400 and the loading mechanism 300 are arranged at intervals on the workbench 500, and the unloading mechanism 400 is used to receive the jig 900 irradiated by the light source 30 and moved out of the housing 10. Specifically, the moving assembly 24 drives the carrying plate 22 to push the jig 900 irradiated by the light source 30 out of the housing 10, and the transfer mechanism 200 grabs the jig 900 irradiated by the light source 30 from the carrying plate 22 pushed out of the housing 10 and places the jig 900 on the unloading mechanism 400.

There may be one or more controllers 700. According to some embodiments, different mechanisms may be electrically connected to different controllers 700. For example, the light source 30 and the transfer mechanism 200 are electrically controlled by different controllers 700. Specifically, the content controlled by different controllers 700 may be controlled by a central controller. For the convenience of understanding, the controller 700 is schematically arranged on the workbench 500. In some embodiments, the controller 700 may also be arranged under the workbench 500 or on an external device. The size of the controller 700 is not limited to that shown in FIG. 5, the location of the controller 700 and the size of the controller 700 may be varied as needs.

The loading mechanism 300 and the unloading mechanism 400 may be conveyor belts used to transport the jig 900, such as the conveyor belt 300a and the conveyor belt 400a shown in FIG. 5.

The curing apparatus 800 may further include support rods 502 and a crossbeam assembly 504. The workbench 500 includes a curing region 5002, a loading region 5004, and unloading region 5006. the loading region 5004 is spaced from the curing region 5002, the unloading region 5006 is located between the curing region 5002 and the loading region 5004. The curing device 100 is located at the curing region 5002, the loading mechanism 300 is located at the loading region 5004, and the unloading mechanism 400 is located at the unloading region 5006.

The crossbeam assembly 504 may include a first longitudinal beam 5042, a first transverse beam 5044, a second longitudinal beam 5046, and a second transverse beam 5048 connected end to end in sequence, and the crossbeam assembly 504 may be a quadrangular frame. The workbench 500 may include four corners. The number of the support rods 502 is four, and the four support rods 502 are arranged at intervals at the four corners of the workbench 500 for supporting the crossbeam assembly 504.

The transfer mechanism 200 may include a transverse movement assembly 202, a longitudinal movement assembly 204, an up and down movement assembly 206, and a gripper assembly 208.

The transverse movement assembly 202 may include a sliding plate 2022, a transverse sliding rail 2024 and a transverse driving member 2026. The sliding plate 2022 straddles the first longitudinal beam 5042 and the second longitudinal beam 5046. The transverse sliding rail 2024 is arranged on the sliding plate 2022. The transverse driving member 2026 is used to drive the up and down movement assembly 206 to slide on the transverse sliding rail 2024. The transverse driving member 2026 may be a linear module.

The longitudinal movement assembly 204 may include two longitudinal slide rails 2042 and a longitudinal driving member 2044. The two longitudinal slide rails 2042 are respectively arranged on the first longitudinal beam 5042 and the second longitudinal beam 5046. The longitudinal driving member 2044 is arranged on the first longitudinal beam 5042 and is used to drive the sliding plate 2022 to slide on the longitudinal sliding rail 2042. The longitudinal driving member 2044 may be a linear module.

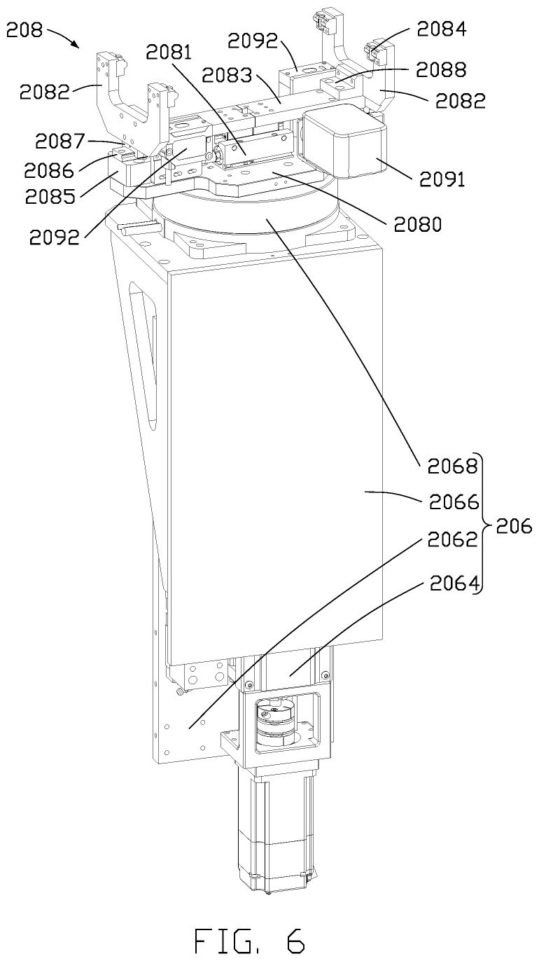

Referring to FIG. 6, the up and down movement assembly 206 may include a moving plate 2062, an up and down driving member 2064, a mounting base 2066 and a rotating driving member 2068. The moving plate 2062 is connected to the transverse driving member 2026, the up and down driving member 2064 is arranged on the moving plate 2062 and connected to the mounting base 2066. The up and down driving member 2064 is used to drive the mounting base 2066 to move up and down. The rotating driving member 2068 is arranged on the mounting base 2066 and connected to the gripper assembly 208. The rotating driving member 2068 is used to drive the gripper assembly 208 to rotate. The up and down driving member 2064 may be a linear module, the rotating driving member 2068 may be a rotary cylinder.

The gripper assembly 208 may include a rotating plate 2080, a gripper driver 2081, two gripper fingers 2082, two gripper connecting plates 2083, four abutting portions 2084, two protrusions 2085, two gripper slide rails 2086, two gripper sliders 2087 and two L-shaped bases 2088. The rotating plate 2080 is connected to the rotating driving member 2068. The gripper driver 2081 is arranged on a middle area of the rotating plate 2080. The protrusions 2085 are respectively arranged at opposite sides of the rotating plate 2080 and respectively arranged at opposite sides of the gripper driver 2081. Each of the gripper slide rails 2086 is arranged on one of the protrusions 2085. Each of the gripper sliders 2087 is slidably connected to one of the gripper slide rails 2086 and connected to a bottom of one end of one gripper connecting plate 2083. A bottom of another end of the gripper connecting plate 2083 is connected to the gripper driver 2081. Each of the gripper fingers 2082 is connected to the end of the gripper connecting plate 2083 to form an L shape through one L-shaped base 2088. Each gripper finger 2082 may be roughly U-shaped, and two of the abutting portions 2084 are arranged on each gripper finger 2082. The abutting portions 2084 on one of the gripper fingers 2082 faces the abutting portions 2084 on another of the gripper fingers 2082. The gripper driver 2081 may be a double-headed linear cylinder and is used to drive the gripper connecting plates 2083 to approach or move away from each other. The gripper connecting plates 2083 can drive the gripper sliders 2087 to slide on the gripper slide rails 2086, so that the gripper fingers 2082 with the abutting portions 2084 can be driven to approach or move away from each other to clamp the jig 900or loosen the jig 900.

According to further embodiments, the transfer mechanism 200 may further include a code scanner 2091 and a height sensor 2092. The code scanner 2091 and the height sensor 2092 are both arranged on the rotating plate 2080 and do not interfere with the gripper assembly 208. The code scanner 2091 is used to scan a code of the jig 900 to identify the basic information of the jig 900 so that the controller 700 can record the curing information of the jig 900 to facilitate subsequent traceability. The basic information includes information such as the model and serial number of the jig 900, the type and serial number of the product. The curing information include which curing device 100 the jig 900 is cured in, the curing time, and the curing parameters (including operating parameters of the light source 30, cooling time of the cooling pipe, and other parameters). The height sensor 2092 is connected to the protrusion 2085 for monitoring a position of the gripper assembly 208 so as to facilitate the pick-up and placement of the jig 900, thereby preventing the gripper assembly 208 from colliding with the loading mechanism 300, the unloading mechanism 400, and the carrying plate 22 when the gripper assembly 208 pick and place the jig 900. The height sensor 2092 may be a distance sensor, an infrared emission sensor or other functional sensors capable of monitoring the relative distance between the gripper 208 and other mechanisms.

A working process of the curing apparatus 800 may be roughly as follow:

Step one, the controller 700 controls the conveyor belt 300a of the loading mechanism 300 to supply the jig 900.

Step two, the controller 700 controls the moving assembly 24 of the curing device 100 to drive the carrying plate 22 to move out of the housing so as to place the jig 900 to be cured on the carrying plate 22.

Step two, the controller 700 controls the height sensor 2092 to detect a distance between the transfer mechanism 200 and the jig 900, so as to control the cooperation of the transverse movement assembly 202, the longitudinal movement assembly 204, and the up and down movement assembly 206 of the transfer mechanism 200 to drive the gripper assembly 208 to be close to the jig 900 on the loading mechanism 300 until the gripper fingers 2082 of the gripper assembly 108 are located on opposite sides of the jig 900, then the gripper driver 2081 of the gripper assembly 108 drives the gripper fingers 2082 to approach each other to grip the jig 900, and the information of the jig 900 is recorded through the code scanner 2091.

Step four, the controller 700 controls the cooperation of the transverse movement assembly 202, the longitudinal movement assembly 204, and the up and down movement assembly 206 of the transfer mechanism 200 to drive the gripper assembly 208 and the gripped jig 900 close to the curing device 100.

Step five, the controller 700 controls the rotating driving member 2068 of the up and down movement assembly 206 to drive the gripper assembly 208 to rotate, so that the jig 900 is rotated to a direction compatible with the carrying plate 22.

Step six, the controller 700 controls the transfer mechanism 200 to place the jig 900 on the carrying plate 22, and controls the moving assembly 24 to drive the carrying plate 22 to move into the housing 10.

Step seven, the controller 700 controls the light source 30 to turn on to irradiate the light transmitting area of the jig 900 to start curing the adhesive.

Step eight, the controller 700 controls the timer to monitor the curing time of the adhesive in the jig 900, and at the same time the controller 700 controls the transverse movement assembly 202, the longitudinal movement assembly 204, and the up and down movement assembly 206 to cooperate to drive the gripper assembly 208 close to clamp another jig 900 and place it on the carrying plate 22 of another curing device 100 for curing.

Step nine, when the curing time of the adhesive monitored by the timer reaches a predetermined time, the controller 700 controls the light source 30 in the curing device 100 to turn off, and controls the air-blowing member 80 in the curing device 100 to to supply air into the housing 10 to reduce the temperature of the jig 900, and then the controller 700 controls the moving assembly 24 to drive the carrying plate 22 to move out of the housing 10.

Step ten, the controller 700 controls the cooperation of the transverse movement assembly 202, the longitudinal movement assembly 204, and the up and down movement assembly 206 of the transfer mechanism 200 to drive the gripper assembly 208 to take away the jig 900 irradiated by the light source 30 from the carrying plate 22.

Step eleven, the controller 700 controls the cooperation of the transverse movement assembly 202, the longitudinal movement assembly 204, and the up and down movement assembly 206 of the transfer mechanism 200 to drive the gripper assembly 208 and the jig 900 with the cured adhesive close to the unloading mechanism 400, then the controller 700 controls the rotating driving member 2068 of the up and down movement assembly 206 to drive the gripper assembly 208 to rotate, so that the jig 900 is rotated to a direction that matches the conveying direction of the unloading mechanism 400.

Step twelve, the controller 700 controls the transfer mechanism 200 to place the jig 900 with the cured adhesive on the conveyor belt 400a of the unloading mechanism 400 so as to facilitate unloading.

The above steps are repeated to realize operations such as loading, curing, retrieving, and unloading.

While the disclosure has been described in detail with only a limited number of embodiments, it should be readily understood for the skilled in the art that the disclosure is not limited to such disclosed embodiments. Rather, the disclosure can be modified to incorporate any number of variations, alterations, substitutions, or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. A curing device comprising:
a housing with an opening;
a carrying plate for carrying a jig receiving a product and an adhesive, the jig comprising a light transmitting area;
a moving assembly disposed in the housing and connected to the carrying plate, the moving assembly being configured for driving the carrying plate to move into and out of the housing from the opening; and
a light source arranged in the housing for irradiating the light transmitting area of the jig to cure the adhesive in the jig.

2. The curing device of claim 1, wherein the moving assembly comprises:
a base plate disposed in the housing;
a sliding block disposed on the base plate;
a guiding rail disposed on the carrying plate and slidably connected to the sliding block; and
a driving member disposed in the housing and adjacent to the base plate, the driving member being connected to the carrying plate for driving the carrying plate to drive the guiding rail to slide on the sliding block.

3. The curing device of claim 2, wherein the curing device further comprises a mounting frame, the mounting frame comprises:
a top plate disposed above the carrying plate for mounting the light source; and
two side plates arranged in the housing and connected to opposite sides of the top plate respectively.

4. The curing device of claim 3, wherein the mounting frame further comprises two mounting brackets, each of the mounting brackets comprises a suspension plate, two suspension plates of the mounting brackets are respectively connected to the top plate at intervals and located on opposite sides of the light source, the suspension plates are located between the side plates, a space between the suspension plates of the mounting brackets is configured to receive the jig.

5. The curing device of claim 4, wherein the jig comprises a top surface facing the top plate and opposite first sides respectively facing the connecting plates;
each of the mounting brackets further comprises a connecting plate, one end portion of the connecting plate is connected to an end portion of the suspension plate to form an L shape, another end portion of the connecting plate is connected to one of side plates adjacent to the connecting plate;
the light source comprises a first light emitting assembly and two second light emitting assemblies, the first light emitting assembly is arranged on the top plate for irradiating a portion of the light transmitting area on the top surface of the jig, the second light emitting assemblies are respectively connected to the connecting plates and respectively located on the first sides of the jig for irradiating portions of the light transmitting area on the first sides of the jig.

6. The curing device of claim 5, wherein the jig further comprises opposite second sides, each of the second sides is connected to the first sides and the top surface;
the light source further comprises two third light emitting assemblies, the third light emitting assemblies are respectively arranged on the carrying plate and respectively located on the second sides of the jig for irradiating portions of the light transmitting area on the second sides of the jig.

7. The curing device of claim 6, wherein a light emitting area of the first light emitting assembly is greater than a light emitting area of one of the second light emitting assemblies or a light emitting area of one of the third light emitting assemblies.

8. The curing device of claim 6, wherein the first light emitting assembly comprises a first light-transmitting shell and at least one first light-emitting member, the first light-transmitting shell defines an annular groove, the at least one first light-emitting member is embedded in the annular groove, and the at least one first light-emitting member is in a strip shape or a ring shape.

9. The curing device of claim 8, wherein each of the second light emitting assemblies and the third light emitting assemblies comprises a second light-transmitting shell defining a strip-shaped groove and at least one second light-emitting member embedded in the strip-shaped groove, the at least one second light-emitting member is granular or in a strip shape.

10. The curing device of claim 9, wherein each of the at least one first light-emitting member and the at least one second light-emitting member is an UV lamp or a blue light lamp.

11. The curing device of claim 5, wherein a through hole is defined in the suspension plate;
the curing device further comprises an air-blowing member, the air-blowing member is located between the top plate and the connecting plate for communicating with an external air source, and configured to blow air to the jig through the through hole to reduce a temperature of the jig.

12. The curing device of claim 1, wherein further comprising:
a cooling pipe in the housing for communicating with an external liquid storage tank, the cooling pipe allowing fluid to circulate between the external liquid storage tank and the housing to reduce a temperature of the light source.

13. The curing device of claim 1, further comprising:
a light sensor disposed in the housing for monitoring a light intensity of the light emitted by the light source; and/or
a temperature sensor disposed in the housing for monitoring a temperature of the jig.

14. A curing apparatus comprising:
a workbench; and
a plurality of curing devices stacked on the workbench, each of the plurality of curing devices comprising:
a housing with an opening;
a carrying plate for carrying a jig receiving a product and an adhesive, the jig comprising a light transmitting area;
a moving assembly disposed in the housing and connected to the carrying plate, the moving assembly being configured for driving the carrying plate to move into and out of the housing from the opening; and
a light source disposed in the housing for irradiating the light transmitting area of the jig to cure the adhesive in the jig.

15. The curing apparatus of claim 14, further comprising:
a loading mechanism arranged on the workbench and spaced from the plurality of the curing devices for transporting and supplying the jig;
a transfer mechanism for moving the jig on the loading mechanism and placing the jig onto the carrying plate;
a controller electrically connected to the transfer mechanism for controlling the light source to turn on to irradiate the light transmitting area of the jig to cure the adhesive in the jig after the jig is moved in the housing; and
an unloading mechanism arranged on the workbench and spaced from the loading mechanism, the unloading mechanism being configured for receiving the jig irradiated by the light source;
wherein the moving assembly is configured to drive the carrying plate to drive the jig irradiated by the light source to move out of the housing, and the transfer mechanism is configured to move the jig irradiated by the light source from the carrying plate to the unloading mechanism.

16. The curing apparatus of claim 15, wherein each of the loading mechanism and the unloading mechanism comprises a conveyor belt for transmitting the jig.

17. The curing apparatus of claim 15, wherein the transfer mechanism comprises:
a gripper assembly for picking and placing the jig;
an up and down movement assembly for driving the gripper assembly to move up and down;
a transverse movement assembly for driving the up and down movement assembly to move horizontally; and
a longitudinal movement assembly for driving the transverse movement assembly to move longitudinally.

18. The curing apparatus of claim 17, wherein the up and down movement assembly comprises:
a moving plate connected to the transverse driving member;
a mounting base;
an up and down driving member arranged on the moving plate and connected to the mounting base for driving the mounting base to move up and down;
a rotating driving member arranged on the mounting base and configured for driving the gripper assembly to rotate.

19. The curing apparatus of claim 18, wherein the gripper assembly comprises:
a rotating plate connected to the rotating driving member,
a gripper driver arranged on the rotating plate,
two protrusions respectively arranged at opposite sides of the rotating plate and respectively arranged at opposite sides of the gripper driver,
two gripper slide rails,
two gripper sliders,
two gripper connecting plates, and
two gripper fingers;
each of the gripper slide rails is arranged on one of the protrusions, each of the gripper sliders is slidably connected to one of the gripper slide rails and a bottom of one end of one of the gripper connecting plates, a bottom of another end of the one of the gripper connecting plates is connected to the gripper driver, each of the gripper fingers is connected to the end of one of the gripper connecting plates, the gripper driver is configured to drive the gripper connecting plates to approach or move away from each other, the gripper connecting plates are configured to drive the gripper sliders to slide on the gripper slide rails, the gripper sliders are configured to drive the gripper fingers to approach or move away from each other to clamp the jig or loosen the jig.

20. The curing apparatus of claim 19, wherein the transfer mechanism further comprises:
a code scanner arranged on the rotating plate and configured to scan a code of the jig to identify a basic information of the jig; and
a height sensor connected to the protrusions for monitoring a position of the gripper assembly.
